(19) United States
(12) Patent Application Publication
(10) Pub. No.: US 2025/0126066 A1
(43) Pub. Date: Apr. 17, 2025

(54) TECHNIQUES FOR END-TO-END OPERATIONS BETWEEN DEVICES

(71) Applicant: QUALCOMM Incorporated, San Diego, CA (US)

(72) Inventors: George CHERIAN, San Diego, CA (US); Sai Yiu Duncan HO, San Diego, CA (US); Abhishek Pramod PATIL, San Diego, CA (US); Alfred ASTERJADHI, San Diego, CA (US); Abdel Karim AJAMI, San Diego, CA (US); Gaurang NAIK, San Diego, CA (US); Yanjun SUN, San Diego, CA (US)

(21) Appl. No.: 18/484,994

(22) Filed: Oct. 11, 2023

(51) Int. Cl. H04L 47/10; H04L 47/2441; H04W 28/02; H04W 28/24; H04W 84/12

(52) U.S. Cl. CPC H04L 47/18; H04L 47/2441; H04W 28/0268; H04W 28/24; H04W 84/12

(57) ABSTRACT

This disclosure provides methods, components, devices and systems for techniques for end-to-end operations between a first wireless station (STA) and a second STA via a wireless access point (AP). Some aspects more specifically relate to indicating one or more quality of service (QOS) parameters to the AP, sharing transmission opportunities (TXOPs) between the first STA and the AP, or both. In some examples, the first STA may identify one or more QoS parameters and may transmit, to the AP, an indication of the one or more QoS parameters, such that the AP may configure the second STA with the one or more QoS parameters. Additionally, or alternatively, the first STA may obtain a TXOP and may share the TXOP with the AP, such that the AP may use the shared TXOP to forward a message received from the first STA to the second STA.

### TECHNICAL FIELD

This disclosure relates to wireless communication and, more specifically, to techniques for end-to-end operations between devices.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, an AP may establish a first communication link with a first STA and a second communication link with a second STA, where the first communication link and the second communication link form an end-to-end connection to enable communications between the first STA and the second STA. However, the first communication link and the second communication link may be associated with different, independent channels, increasing latency of the communications between the first STA and the second STA. Additionally, or alternatively, the first STA may communicate a message to the AP, for forwarding to the second STA, in accordance with a quality of service (QOS) threshold. However, the AP, the second STA, or both, may be unaware of the QoS threshold and may fail to meet the QoS threshold due to the lack of awareness.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a first wireless device. The first wireless device may include a processing system that includes processor circuitry and memory circuitry that stores code. The processing system may be configured to cause the first wireless device to establish an end-to-end connection with a second wireless device, the end-to-end connection including a first communication link between the first wireless device and a third wireless device and a second communication link between the third wireless device and the second wireless device, transmit, to the third wireless device, one or both of a shared transmission opportunity (TXOP) reservation request or a stream classification service (SCS) request, where the shared TXOP reservation request is associated with a shared TXOP for a first transmission from the first wireless device to the third wireless device and a second transmission from the third wireless device to the second wireless device, and where the SCS request indicates an identifier of the second wireless device and one or more quality of service parameters common to packets transmitted via the first communication link and via the second communication link, and transmit, via the third wireless device, a first message to the second wireless device in accordance with the shared TXOP reservation request or the SCS request.

Another innovative aspect of the subject matter described in this disclosure can be implemented in a method for wireless communication by a first wireless device. The method may include establishing an end-to-end connection with a second wireless device, the end-to-end connection including a first communication link between the first wireless device and a third wireless device and a second communication link between the third wireless device and the second wireless device, transmitting, to the third wireless device, one or both of a shared TXOP reservation request or a SCS request, where the shared TXOP reservation request is associated with a shared TXOP for a first transmission from the first wireless device to the third wireless device and a second transmission from the third wireless device to the second wireless device, and where the SCS request indicates an identifier of the second wireless device and one or more quality of service parameters common to packets transmitted via the first communication link and via the second communication link, and transmitting, via the third wireless device, a first message to the second wireless device in accordance with the shared TXOP reservation request or the SCS request.

Another innovative aspect of the subject matter described in this disclosure can be implemented in a first wireless device. The first wireless device may include means for establishing an end-to-end connection with a second wireless device, the end-to-end connection including a first communication link between the first wireless device and a third wireless device and a second communication link between the third wireless device and the second wireless device, means for transmitting, to the third wireless device, one or both of a shared TXOP reservation request or a SCS request, where the shared TXOP reservation request is associated with a shared TXOP for a first transmission from the first wireless device to the third wireless device and a second transmission from the third wireless device to the second wireless device, and where the SCS request indicates an identifier of the second wireless device and one or more quality of service parameters common to packets transmitted via the first communication link and via the second communication link, and means for transmitting, via the third wireless device, a first message to the second wireless device in accordance with the shared TXOP reservation request or the SCS request.

Another innovative aspect of the subject matter described in this disclosure can be implemented in a non-transitory computer-readable medium storing code for wireless communication by a first wireless device. The code may include instructions executable by one or more processors, individually or collectively, to establish an end-to-end connection with a second wireless device, the end-to-end connection including a first communication link between the first wireless device and a third wireless device and a second communication link between the third wireless device and the second wireless device, transmit, to the third wireless device, one or both of a shared TXOP reservation request or a SCS request, where the shared TXOP reservation request is associated with a shared TXOP for a first transmission from the first wireless device to the third wireless device and a second transmission from the third wireless device to the second wireless device, and where the SCS request indicates an identifier of the second wireless device and one or more quality of service parameters common to packets transmitted via the first communication link and via the second communication link, and transmit, via the third wireless device, a first message to the second wireless device in accordance with the shared TXOP reservation request or the SCS request.

Some examples of the method, wireless devices, and non-transitory computer-readable medium described herein may further include operations, features, means, or instructions for receiving, from the third wireless device, an acknowledgment message in response to the first message and transmitting, to the third wireless device and in response to the acknowledgment message, a control frame indicating that the shared TXOP may be transferred to the third wireless device.

Some examples of the method, wireless devices, and non-transitory computer-readable medium described herein may further include operations, features, means, or instructions for receiving, from the third wireless device and in response to the control frame, a second message acknowledging that the shared TXOP may be transferred to the third wireless device.

In some examples of the method, wireless devices, and non-transitory computer-readable medium described herein, the shared TXOP reservation request may be transmitted in accordance with a determination that the third wireless device is to forward the first message to the second wireless device via the second communication link for the end-to-end connection with the second wireless device.

Another innovative aspect of the subject matter described in this disclosure can be implemented in a first wireless device. The first wireless device may include a processing system that includes processor circuitry and memory circuitry that stores code. The processing system may be configured to cause the first wireless device to establish a first communication link with a second wireless device, establish a second communication link with a third wireless device different from the second wireless device, the first communication link and the second communication link forming an end-to-end connection between the second wireless device and the third wireless device, receive, from the second wireless device, one or both of a shared TXOP reservation request or a first SCS request, where the shared TXOP reservation request is associated with a shared TXOP for a first transmission from the second wireless device to the first wireless device and a second transmission from the first wireless device to the third wireless device, and where the first SCS request indicates an identifier of the third wireless device and one or more quality of service parameters common to packets transmitted via the first communication link and via the second communication link, and forward, to the third wireless device, a message received from the second wireless device in accordance with the shared TXOP reservation request or the first SCS request.

Another innovative aspect of the subject matter described in this disclosure can be implemented in a method for wireless communication by a first wireless device. The method may include establishing a first communication link with a second wireless device, establishing a second communication link with a third wireless device different from the second wireless device, the first communication link and the second communication link forming an end-to-end connection between the second wireless device and the third wireless device, receiving, from the second wireless device, one or both of a shared TXOP reservation request or a first SCS request, where the shared TXOP reservation request is associated with a shared TXOP for a first transmission from the second wireless device to the first wireless device and a second transmission from the first wireless device to the third wireless device, and where the first SCS request indicates an identifier of the third wireless device and one or more quality of service parameters common to packets transmitted via the first communication link and via the second communication link, and forwarding, to the third wireless device, a message received from the second wireless device in accordance with the shared TXOP reservation request or the first SCS request.

Another innovative aspect of the subject matter described in this disclosure can be implemented in a first wireless device. The first wireless device may include means for establishing a first communication link with a second wireless device, means for establishing a second communication link with a third wireless device different from the second wireless device, the first communication link and the second communication link forming an end-to-end connection between the second wireless device and the third wireless device, means for receiving, from the second wireless device, one or both of a shared TXOP reservation request or a first SCS request, where the shared TXOP reservation request is associated with a shared TXOP for a first transmission from the second wireless device to the first wireless device and a second transmission from the first wireless device to the third wireless device, and where the first SCS request indicates an identifier of the third wireless device and one or more quality of service parameters common to packets transmitted via the first communication link and via the second communication link, and means for forwarding, to the third wireless device, a message received from the second wireless device in accordance with the shared TXOP reservation request or the first SCS request.

Another innovative aspect of the subject matter described in this disclosure can be implemented in a non-transitory computer-readable medium storing code for wireless communication by a first wireless device. The code may include instructions executable by one or more processors, individually or collectively, to establish a first communication link with a second wireless device, establish a second communication link with a third wireless device different from the second wireless device, the first communication link and the second communication link forming an end-to-end connection between the second wireless device and the third wireless device, receive, from the second wireless device, one or both of a shared TXOP reservation request or a first SCS request, where the shared TXOP reservation request is associated with a shared TXOP for a first transmission from the second wireless device to the first wireless device and a second transmission from the first wireless device to the third wireless device, and where the first SCS request indicates an identifier of the third wireless device and one or more quality of service parameters common to packets transmitted via the first communication link and via the second communication link, and forward, to the third wireless device, a message received from the second wireless device in accordance with the shared TXOP reservation request or the first SCS request.

Some examples of the method, wireless devices, and non-transitory computer-readable medium described herein may further include operations, features, means, or instructions for receiving the message from the second wireless device, transmitting, to the second wireless device, an acknowledgment message in response to the message, and receiving, from the second wireless device and in response to the acknowledgment message, a control frame indicating that the shared TXOP may be transferred to the first wireless device, the message may be forwarded to the third wireless device in accordance with the shared TXOP being transferred to the first wireless device.

Some examples of the method, wireless devices, and non-transitory computer-readable medium described herein may further include operations, features, means, or instructions for transmitting, to the second wireless device and in response to the control frame, a second message acknowledging that the shared TXOP may be transferred to the first wireless device.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIGS. 1 and 2 show pictorial diagrams of example wireless communication networks that support techniques for end-to-end operations between devices.

FIGS. 3 and 4 show example signaling diagrams that support techniques for end-to-end operations between devices.

FIG. 5 shows an example process flow that supports techniques for end-to-end operations between devices.

FIGS. 6 and 7 show block diagrams of example wireless communication devices that support techniques for end-to-end operations between devices.

FIGS. 8 and 9 show flowcharts illustrating example processes performable by or at a first wireless device that support techniques for end-to-end operations between devices.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to communications between respective wireless stations (STAs) via an end-to-end connection through a wireless access point (AP), for example, where the AP may serve as a relay between two or more peer wireless STAs. Some aspects more specifically relate to sharing transmission opportunities (TXOPs) between a transmitting STA and the AP. Additionally, or alternatively, some aspects relate to indicating, to the AP, one or more quality of service (QoS) parameters associated with a message, where the one or more QoS parameters may be applied when the message is forwarded to another STA. In any case, the described techniques may enable reduced latency across the end-to-end connection.

In some examples, a first STA may establish an end-to-end connection with a second STA via one or more APs, where the end-to-end connection includes a first communication link between the first STA and the AP and a second communication link between the AP and the second STA. The first STA may obtain (such as via a reservation message) a TXOP for transmission of a message to the second STA via the AP, and the first STA may share the TXOP with the AP, such that the AP may also use the shared TXOP to forward the message received from the first STA to the second STA. Here, a shared TXOP may refer to a TXOP that enables transmission of messages by two or more devices such that, after a first device transmits a message during the TXOP, the TXOP has enough remaining time for one or more other devices to transmit other messages during the same TXOP. In some cases, a shared TXOP may be referred to as a long TXOP, or some other terminology. In some implementations, the first STA may implicitly transfer ownership of the shared TXOP to the AP, based on transmission of a control frame (such as a shared TXOP reservation request) to the AP. Additionally, or alternatively, the first STA may explicitly transfer ownership of the shared TXOP to the AP in accordance with a transmission of a control frame (such as a TXOP transfer message). For messages transmitted from the second STA to the first STA via the AP, the second STA may use the same or similar techniques for reserving a shared TXOP that is used by both the second STA and the AP.

Additionally, or alternatively, the first STA may identify one or more QoS parameters common to packets transmitted via the first communication link and via the second communication link and may transmit, to the AP, a stream classification service (SCS) request indicating the one or more QoS parameters, such that the AP may configure the second STA with the one or more QoS parameters. The SCS request may further include information that identifies the second STA, such as an identifier associated with the second STA (such as a medium access control (MAC) address or another identifier). Based on receiving the SCS request and the indication of the QoS parameters, the AP may apply the one or more QoS parameters when forwarding messages from the first STA to the second STA. In some aspects, the AP may install the QoS parameters at the second STA, and the second STA may apply the one or more parameters to transmission of messages from the second STA to the first STA (via the AP). When transmitting data to the first STA via the AP, in some examples, the second STA may transmit an SCS request that includes information identifying the first STA and one or more QoS parameters.

Particular aspects of the subject matter described in this disclosure can be implemented to realize one or more of the following potential advantages. In some examples, sharing of a TXOP for a transmission via the end-to-end connection may enable the AP to refrain from performing independent channel access to obtain a channel to forward a message received from the first STA to the second STA. Refraining from performing independent channel access at the AP may reduce latency of communications via the end-to-end connection between the first STA and the second STA. Additionally, by indicating one or more QoS parameters to the AP, the described techniques may allow the AP and the second STA to apply the one or more QoS parameters to subsequent transmissions to or from the first STA, which may ensure efficient prioritization of packets (such as packets that are associated with latency-sensitive applications). Here, the prioritization enabled by the installation of the one or more QoS parameters and the application of the one or more QoS parameters to transmissions sent via the end-to-end connection may reduce and/or minimize latency of communications via the end-to-end connection between the first STA and the second STA.

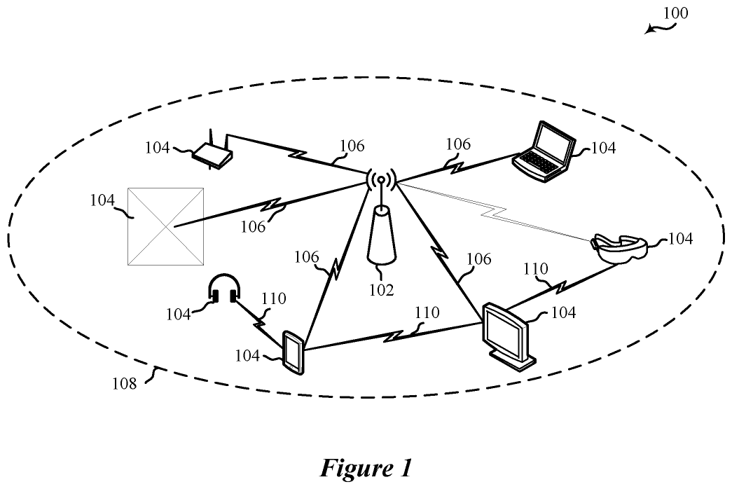

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one AP 102 and any number of STAs 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a MAC address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a relatively larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

XR is a technology with potential to become a leading product in the personal electronics segment in the next decade. In some examples, XR technology may include augmented reality (AR) technologies, virtual reality (VR) technologies, mixed reality (MR) technologies, among other examples. XR technology and corresponding data communications may, in some examples, be associated with various parameters, use cases, and conditions that make the technology susceptible to challenges, including device weight, processing complexity, latency thresholds, and power consumption. For example, some XR devices may be relatively heavier than regular glasses, and some XR devices may not be appropriate for extended-time and/or portable use scenarios. Battery weight may be relatively limited to reduce total XR device weight. Processing complexity and power consumption may be relatively limited due to a reduced heat dissipation capacity of an XR device. For instance, the heat dissipation capacity of an XR device may be relatively smaller than that of a handheld wireless device, because the heat dissipation capacity of an XR device may be proportional to the surface size of the XR device (such as goggles, glasses). For some XR devices (such as smart XR wearable goggles), power consumption may be limited to a few Watts (W) due to limited heat dissipation capacity. In some cases, data traffic associated with XR applications may be subject to relatively strict latency thresholds, because various movements, actions, inputs, and other features associated with XR application data (such as image data, video data, or the like) may be time-dependent and latency sensitive. Additionally, power consumption may be limited to allow a lightweight battery to provide a target battery duration. Constrained battery weight, processing complexity, latency, and power consumption provide significant challenges in view of the relatively heavy processing demands to support some XR applications. In accordance with the techniques described herein, XR traffic (among other types of data) communicated via an end-to-end link (such as traffic from one peer STA to another peer STA sent via another device, such as an AP) may satisfy one or more latency thresholds to ensure relatively reduced latency and efficient communications.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs). A PPDU may be equivalently understood as a Physical Layer Convergence Protocol (PLCP) protocol data unit.

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHZ-52.6 GHz), FR3 (7.125 GHZ-24.25 GHZ), FR4a or FR4-1 (52.6 GHz-71 GHz), FR4 (52.6 GHz-114.25 GHZ), and FR5 (114.25 GHZ-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

The wireless communication network 100 may support techniques for sharing TXOPs between a transmitting STA 104 and one or more APs 102. Additionally, or alternatively, the wireless communication network 100 may support techniques for indicating, by a transmitting STA 104 to one or more APs 102, one or more QoS parameters associated with a message, where the one or more QoS parameters may be applied when the message is forwarded to another STA 104. The described techniques supported by wireless communication network 100 may enable reduced latency across the end-to-end connection.

In some examples, a first STA 104 may establish an end-to-end connection with a second STA 104 via one or more APs 102, where the end-to-end connection includes a first communication link between the first STA 104 and the AP 102 and a second communication link between the AP 102 and the second STA 104. The first STA 104 may obtain (such as via a reservation message) a TXOP for transmission of a message to the second STA 104 via the AP 102, and the first STA 104 may share the TXOP with the AP 102, such that the AP 102 may also use the shared TXOP to forward the message received from the first STA 104 to the second STA 104. As described herein, a shared TXOP may refer to one or more TXOPs that enables transmission of messages by two or more devices such that, after a first device transmits a message during the TXOP, the TXOP has enough remaining time for one or more other devices (such as one or more APs 102) to transmit other messages during the same TXOP. In some cases, a shared TXOP may be referred to as a “long TXOP,” or some other terminology. In some implementations, the first STA 104 may implicitly transfer ownership of the shared TXOP to the AP 102, based on transmission of a control frame (such as a shared TXOP reservation request) to the AP 102. Additionally, or alternatively, the first STA 104 may explicitly transfer ownership of the shared TXOP to the AP 102 in accordance with a transmission of a control frame (such as a TXOP transfer message). For messages transmitted from the second STA 104 to the first STA 104 via one or more APs 102, the second STA 104 may use the same or similar techniques for reserving a shared TXOP that is used by both the second STA 104 and the one or more APs 102.

In some examples, the first STA 104 may identify one or more QoS parameters common to packets transmitted via the first communication link and via the second communication link and may transmit, to the AP 102, an SCS request indicating the one or more QoS parameters, such that the AP 102 may configure the second STA 104 with the one or more QoS parameters. The SCS request may further include information that identifies the second STA 104, such as an identifier associated with the second STA 104 (such as a MAC address or another identifier). Based on receiving the SCS request and the indication of the QoS parameters, the AP 102 may apply the one or more QoS parameters when forwarding messages from the first STA 104 to the second STA 104. In some aspects, the AP 102 may install the QoS parameters at the second STA 104, and the second STA 104 may apply the one or more parameters to transmission of messages from the second STA 104 to the first STA 104 (via the AP 102). When transmitting data to the first STA 104 via the AP 102, in some examples, the second STA 104 may transmit an SCS request that includes information identifying the first STA 104 and one or more QoS parameters.

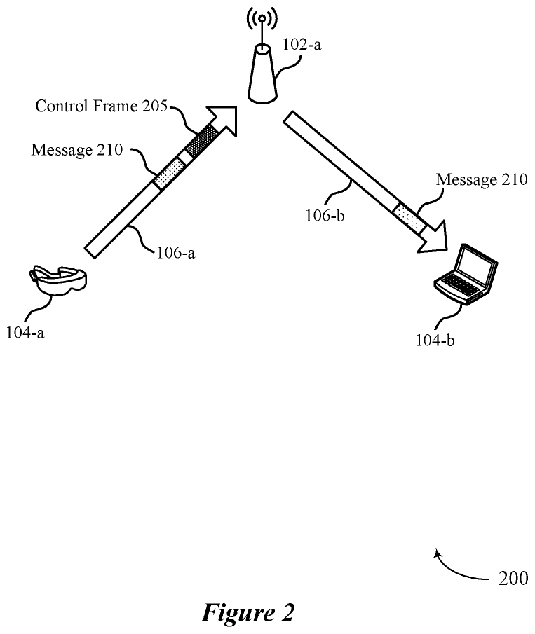

FIG. 2 shows a pictorial diagram of an example wireless communication network 200 that supports techniques for end-to-end operations between devices. The wireless communication network 200 may implement or may be implemented by aspects of the wireless communication network 100. For example, the wireless communication network 200 may include an AP 102-a, which may be an example of an AP 102 described with reference to FIG. 1. The wireless communication network 200 may further include two or more STAs 104 (such as an STA 104-a, an STA 104-b, and so on), which may each be an example of an STA 104 described with reference to FIG. 1. The wireless communication network 200 may support techniques for establishing shared TXOPs and/or installation of QoS parameters at a receiving device to reduce latency of an end-to-end connection (such as a connection that includes one or more devices that forward and/or relay communications between wireless devices).

As shown in FIG. 2, an AP 102-a may establish a communication link 106-a with an STA 104-a (such as a first peer device) and a communication link 106-b with an STA 104-b (such as a second peer device). In such implementations, at least the communication link 106-a and the communication link 106-b may form an end-to-end connection between the STA 104-a and the STA 104-b. In other words, the communication link 106-a and the communication link 106-b may enable the STA 104-a to transmit messages to the STA 104-b (and vice versa) via the AP 102-a, which may be referred to as end-to-end communications.

Some examples of communications between the STA 104-a and the STA 104-b (such as XR communications) may be associated with one or more latency thresholds. For example, the communications between the STA 104-a and the STA 104-b (via the AP 102-a) may be associated with one or more end-to-end one-way latency thresholds. In such cases, communications from the STA 104-a to the STA 104-b (or vice versa) may be affected when the communications do not satisfy the one or more end-to-end one-way latency thresholds (such as in cases where the communication may require some end-to-end one-way latency). For example, a latency threshold may be associated with a 5 millisecond (ms) median delay threshold (such as a 5 millisecond end-to-end one-way delay). In such examples, a delay between transmission of a message 210 (such as a data packet, a data frame, or a data message) by the STA 104-a and reception of the message 210 by the STA 104-b (or vice versa) may be successful if the delay is less than 5 ms. In another example, a latency threshold may be associated with a 95th percentile latency of 10 ms (such that 95 percent of one-way messages are received within 10 ms of transmission). In any case, a relatively limited (short) latency threshold may present challenges in the wireless communication network 200, particularly in cases where an end-to-end connection may include respective links between different wireless devices.

In some cases, the communication link 106-a and the communication link 106-b may each be associated with independent channel access (such as two independent channel accesses). For example, the STA 104-a (such as a glass or a compute device) may access a first channel over the communication link 106-a and may transmit a message 210 (such as a packet, a data packet, a data frame, or a data message) to the AP 102-a. The AP 102-a may access a second channel over the communication link 106-b and may forward the message 210 to the STA 104-b (such as a computed device or a glass). In other words, the STA 104-a and the AP 102-a may each independently access a channel for transmission of the message 210. Performing independent channel access for each communication link 106 may result in increased latency for end-to-end communications from the STA 104-a to the STA 104-b via the AP 102-a (or vice versa).

Additionally, or alternatively, one or more of the STA 104-a, the AP 102-a, and the STA 104-b may not be aware of priorities associated with performing an end-to-end communication between the STA 104-a and the STA 104-b (such as the STA 104-a or the STA 104-b may be a legacy or general purpose computer or mobile phone device). For example, a message 210 transmitted by the STA 104-a may be associated with a QoS (such as an application QoS), however, the STA 104-b may not be aware of the QoS. As such, the STA 104-b may not be aware of or attempt to meet the QoS. In some examples, channel access performed by the STA 104-b associated with the communication link 106-b may default to some access category, such as a “Best Effort” access category, that does not support meeting of the QoS requirements for the data/application traffic. That is, an access category such as the “Best Effort” access category may increase latency in a presence of other traffic, such that the increase in latency causes the STA 104-b to fail to meet, or satisfy, the QoS requirements.

As such, the STA 104-a, the STA 104-b, the AP 102-a, or any combination thereof, may employ end-to-end TXOP techniques, end-to-end QoS techniques, or both, to reduce latency for end-to-end communications via the AP 102-a. In a first example, the STA 104-a may employ end-to-end TXOP techniques to transmission of a message 210 from the STA 104-a to the STA 104-b via the AP 102-a to reduce latency of transmission of the message 210. In such implementations, the STA 104-a may obtain a TXOP (such as an uplink TXOP) and may share the TXOP with the AP 102-a, such that the AP 102-a may use the shared TXOP, such as same TXOP, to forward a message 210 (such as one or more MAC Protocol Data Unit (MPDUs) or PPDUs) from the STA 104-a to the STA 104-b (such as on downlink). That is, in accordance with the described techniques, a shared TXOP may be used for both uplink messages and downlink messages and by multiple devices (such as various devices associated with an end-to-end connection between peer wireless devices).

The STA 104-a may transmit, to the AP 102-a, a control frame 205 including a shared TXOP request, where the shared TXOP request is associated with a TXOP reserved for an end-to-end communication from the STA 104-a to the STA 104-b. In other words, the TXOP may be reserved for a first transmission from the STA 104-a to the AP 102-a and a second transmission from the AP 102-a to the STA 104-b (such as the AP 102-a may not be allowed to use the TXOP for transmissions to a device other than the STA 104-b). In some implementations, the control frame 205 may further include one or more parameters (such as new information) associated with the STA 104-b, such that the AP 102-a may forward the message 210 to the STA 104-b based on the one or more parameters. As such, the STA 104-a may transmit the message 210 to the AP 102-a during a first portion of the TXOP and the AP 102-a may forward the message 210 to the STA 104-b during a second portion of the TXOP.

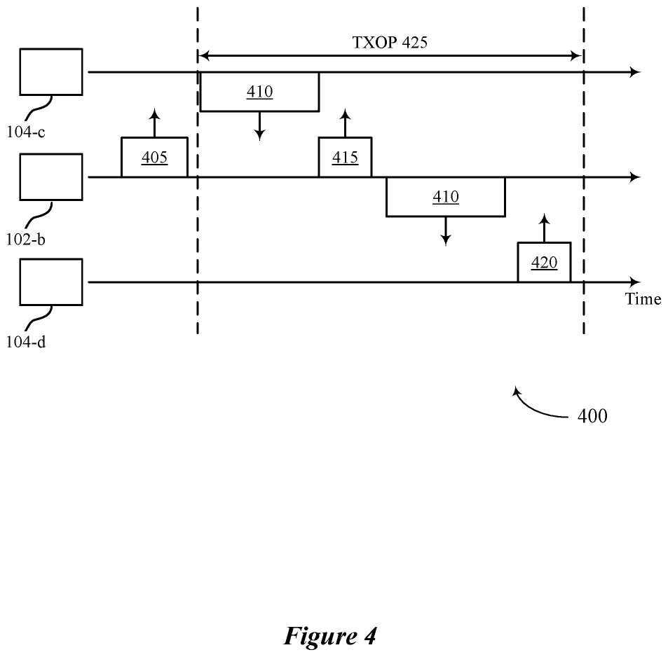

In a second example, the STA 104-a may employ end-to-end QoS techniques to transmission of a message 210 from the STA 104-a to the STA 104-b via the AP 102-a to reduce latency of transmission of the message 210 (such as compared to not employing end-to-end QoS techniques), as described with reference to FIG. 4. In such implementations, the STA 104-a, which is aware of one or more QoS parameters associated with the message 210, may transmit an indication of the one or more QoS parameters to the AP 102-a (such as setup a QoS with the AP 102-a), such that the AP 102-a may apply the one or more QoS parameters to forwarding of the message 210 (such as apply the one or more QoS parameters for downlink access for the message 210), may configure the STA 104-b with the one or more QoS parameters (such as for uplink access of IP data flows specified by the STA 104-a), or both.

For example, the STA 104-a may transmit, to the AP 102-a, a control frame 205 including a first SCS request. The first SCS request may indicate an identifier of the STA 104-b and indicate one or more QoS parameters associated with the message 210. In other words, the one or more QoS parameters may be common to packets (such as MPDUs) transmitted via the communication link 106-a and via the communication link 106-b (such as via the end-to-end connection between the STA 104-a and the STA 104-b via the AP 102-a). The AP 102-a may transmit, to the STA 104-b, a second SCS request to configure the STA 104-b with the one or more QoS parameters. In other words, the STA 104-b may install the one or more QoS parameters (at the STA 104-a) based on receiving the second SCS request. Additionally, the STA 104-b may transmit, to the AP 102-a, a first SCS response indicating a status of the installation, or configuration, of the one or more QoS parameters at the STA 104-b. The AP 102-a may transmit, to the STA 104-a, a second SCS response indicating successful installation of the one or more QoS parameters at the STA 104-b. Thus, the STA 104-a may transmit the message 210 to the AP 102-a in accordance with the one or more QoS parameters and the AP 102-a may similarly forward the message 210 to the STA 104-b in accordance with the one or more QoS parameters.

In a third example, the STA 104-a may employ both the end-to-end QoS techniques and the end-to-end TXOP techniques to transmission of a message 210 from the STA 104-a to the STA 104-b via the AP 102-a. In such an example, the control frame 205 illustrated in the example of the wireless communication network 200 may include or refer to a single control frame or multiple control frames. For example, the STA 104-a may transmit, to the AP 102-a, a first control frame 205 including the first SCS request, such that the AP 102-a may configure the STA 104-b with the one or more QoS parameters indicated via the first SCS request. Additionally, the STA 104-a may transmit, to the AP 102-a, a second control frame 205 (or include in the first control frame 205) including the shared TXOP request, such that the STA 104-a may share the TXOP with the AP 102-a. In other words, the STA 104-a may transmit an SCS request and a shared TXOP request (such as a TXOP transfer request or a shared TXOP reservation request) via different (control) frames, or via different fields or elements of a same (control) frame. As such, the STA 104-a may transmit the message 210 (such as a data packet, a data message, or a data frame) to the AP 102-a in a first portion of the TXOP and in accordance with the one or more QoS parameters and the AP 102-a may forward the message 210 to the STA 104-b in a second portion of the TXOP and in accordance with the one or more QoS parameters.

In some implementations, the STA 104-a and the AP 102-a may communicate (such as transmit or receive, or both) one or more management frames including information indicative of an identifier of the STA 104-b and the one or more QoS parameters. In such implementations, the one or more management frames may be associated with (such as communicated in accordance with or otherwise as part of) a negotiation of the identifier of the STA 104-b and the one or more QoS parameters between the STA 104-a and the AP 102-a. In accordance with such a negotiation of the identifier of the STA 104-b and the one or more QoS parameters, the AP 102-a may select (such as ascertain, identify, or otherwise determine) to forward the message 210 to the STA 104-b in accordance with receiving a TXOP reservation request (such as a shared TXOP request or a TXOP transfer request) from the STA 104-a. For example, in accordance with such a “pre-negotiation” of the identifier of the STA 104-b and the one or more QoS parameters, the AP 102-a may select (or otherwise know, ascertain, identify, or determine) to forward the message 210 to the STA 104-b when the AP 102-a receives the shared TXOP reservation request.

Though described in the context of the STA 104-a transmitting a message 210 to the STA 104-b via the AP 102-a, this is not to be regarded as a limitation of the present disclosure. In this regard, end-to-end TXOP techniques and end-to-end QoS techniques may similarly be employed for messages 210 transmitted from the STA 104-b to the STA 104-a via the AP 102-a. Additionally, though described with reference to an AP 102 and multiple STAs 104, this is not to be regarded as a limitation of the present disclosure. In this regard, any type, or types, of wireless devices may support end-to-end TXOP techniques and end-to-end QoS techniques.

Further, although described in the context of transmitting one or both of a shared TXOP request (such as a TXOP transfer request) or an SCS request via one or multiple control frames 205 (which may include an MU RTS with an extension or a control frame dedicated to conveying information associated with a shared TXOP request or an SCS request) in the example of the wireless communication network 200, the STA 104-a may additionally, or alternatively, transmit one or both of a shared TXOP request or an SCS request via one or more other frames, messages, or packets. In some implementations, for example, the STA 104-a may transmit one or both of a shared TXOP request or an SCS request via a header (such as a MAC header) of the message 210 (such as via a header of an MPDU or a PPDU including the message 210). In other words, the message 210 may be understood as an MPDU or a PPDU (such as an uplink MPDU or PPDU) or may be understood as a data payload portion of an MPDU or a PPDU and, in any case, the STA 104-a may use one or more fields or bits of a header of the MPDU or the PPDU to indicate or otherwise convey one or both of a shared TXOP request or an SCS request. In some examples, the STA 104-a may include information indicative of one or both of a shared TXOP request or an SCS request (or the requests themselves) in one or more aggregated control (A-Control) fields of a MAC header of the uplink MPDU or PPDU. Additionally, or alternatively, the STA 104-a may include information indicative of one or both of a shared TXOP request or an SCS request (or the requests themselves) in a TXOP Transfer control field in a MAC header of the uplink MPDU or PPDU.

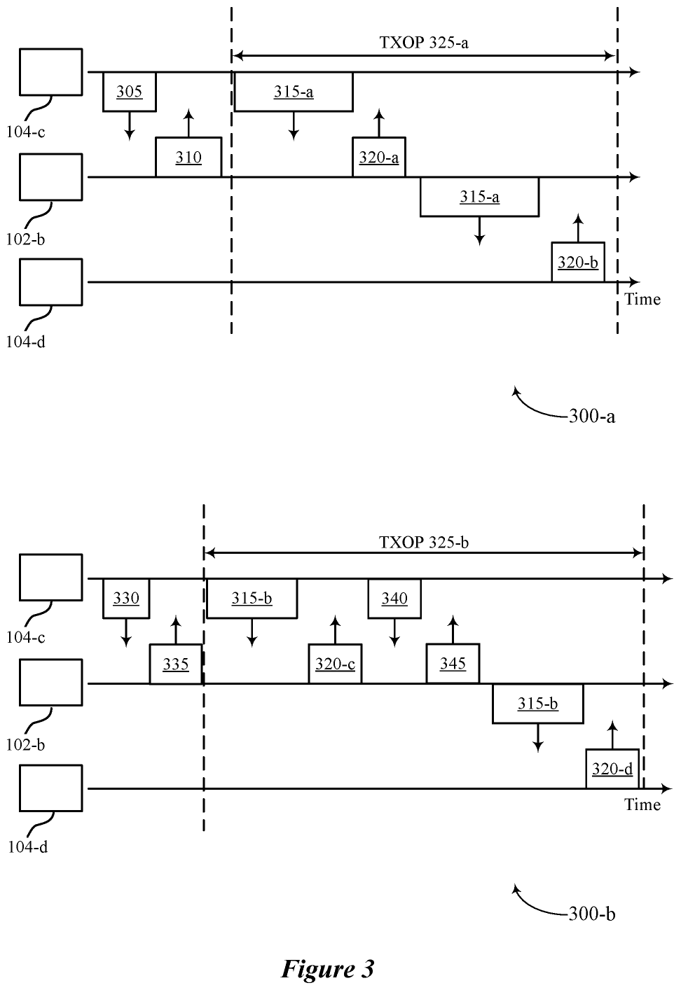

FIG. 3 shows example signaling diagrams 300 (such as a signaling diagram 300-a and a signaling diagram 300-b) that supports techniques for end-to-end operations between devices. The signaling diagrams 300 may implement or may be implemented by aspects of the wireless communication network 100, the wireless communication network 200, or both.

A first example signaling diagram 300-a shows end-to-end TXOP techniques associated with implicit TXOP ownership transfer. A second example signaling diagram 300-b shows end-to-end TXOP techniques associated with explicit TXOP ownership transfer. In both the signaling diagram 300-a and the signaling diagram 300-b, an STA 104-c may establish an end-to-end connection with an STA 104-d via an AP 102-b, where the end-to-end connection includes a first communication link between the STA 104-c and the AP 102-b and a second communication link between the AP 102-b and the STA 104-d.

In the first example signaling diagram 300-a, the STA 104-c may obtain a TXOP 325-a (such as a shared TXOP 325) and may share the TXOP 325-a with the AP 102-b, in which the STA 104-c transfers ownership, or use, of the TXOP 325-a from the STA 104-c to the AP 102-b implicitly (such as without an explicit indication). For example, the STA 104-c may transmit, to the AP 102-b, a control frame including a shared TXOP reservation request 305 (such as a TXS-Rsv), where the shared TXOP reservation request 305 may configure, or set up, the TXOP 325-a with implicit ownership transfer. The TXOP 325-a may be referred to as a long TXOP 325, or a TXOP 325 that supports a first transmission from the STA 104-c to the AP 102-b and a second transmission from the AP 102-b to the STA 104-d. A long TXOP 325 also may be referred to as an end-to-end TXOP 325. In some implementations, the control frame may be a multi-user (MU) request-to-send (RTS) 330 with an extension (such as a new extension, such as an extension field or element) indicating the shared TXOP reservation request 305 or may be a control frame (such as a new control frame) dedicated to the shared TXOP reservation request 305. In other words, the shared TXOP reservation request 305 may be realized using an MU RTS frame with an extension (such as an extension element or field) to indicate a TXOP transfer request.

The AP 102-b may transmit, to the STA 104-c and responsive to the shared TXOP reservation request 305, a shared TXOP reservation response 310 (such as a TXS-Rsv-Resp). The shared TXOP reservation response 310 may acknowledge sharing of the TXOP 325-a. The reception of the shared TXOP reservation response 310 may indicate that a channel between the STA 104-c and the AP 102-b is reserved (such as for transmitting one or more messages). Instead of, or in addition to, exchanging the shared TXOP reservation request 305 and the shared TXOP reservation response 310, the STA 104-c and the AP 102-b may support an RTS-clear-to-send (CTS) frame exchange in association with the STA 104-c setting up the TXOP 325-a. For example, the STA 104-c may transmit an RTS frame and the AP 102-b may transmit a CTS frame associated with (such as responsive to) the RTS frame.

Additionally, the STA 104-c may transmit a PPDU 315-a (in the form of an uplink PPDU 315, and which may be equivalently understood as a data packet, a data message, or a data frame) to the AP 102-b during a first portion of the TXOP 325-a and may receive, from the AP 102-b, a block acknowledgment (BA) 320-a in response to the PPDU 315-a, where the BA 320-a indicates successful receipt of the PPDU 315-a. In some implementations, such as in implementations in which the STA 104-c and the AP 102-b support an RTS-CTS frame exchange in association with the STA 104-c setting up the TXOP 325-a (without communicating the shared TXOP reservation request 305 and the shared TXOP reservation response 310 via separate frames prior to the PPDU 315-a), the STA 104-c may include a field in a header of the PPDU 315-a (or in a header of an MPDU associated with the PPDU 315-a) to transfer ownership of the TXOP 325-a to the AP 102-b. For example, the STA 104-c may indicate a TXOP transfer to the AP 102-b via a TXOP transfer control field in a MAC header associated with the PPDU 315-a. Ownership of the TXOP 325-a may transfer from the STA 104-c to the AP 102-b based on the STA 104-c transmitting the PPDU 315-a or based on reception of the BA 320-a by the STA 104-c. The AP 102-b may forward, or transmit, the PPDU 315-a (in the form of a downlink PPDU 315) to the STA 104-d based on transmitting the BA 320-a. The STA 104-d may transmit, to the AP 102-b, a BA 320-b in response to receiving the PPDU 315-a.

In the second example signaling diagram 300-b, the STA 104-c may obtain a TXOP 325-b (such as an uplink TXOP 325) and may share the TXOP 325-b with the AP 102-b, in which the STA 104-c transfers ownership, or use, of the TXOP 325-b from the STA 104-c to the AP 102-b via explicit signaling. For example, the STA 104-c may transmit, to the AP 102-b, a control frame including a RTS 330, where the RTS 330 may configure, or set up, the TXOP 325-a. In other words, the RTS 330 may be a shared TXOP reservation request 305 (such as a TXS-Rsv). The TXOP 325-b may be a long TXOP 325.

The AP 102-b may transmit, to the STA 104-c and responsive to RTS 330, a CTS 335. The CTS 335 may acknowledge sharing of the TXOP 325-b. In other words, the CTS 335 may be a shared TXOP reservation response 310 (such as a TXS-Rsv-Resp). Additionally, the STA 104-c may transmit a PPDU 315-b (in the form of an uplink PPDU 315, and which may be equivalently understood as a data packet, a data message, or a data frame) to the AP 102-b during a first portion of the TXOP 325-b and may receive, from the AP 102-b, a BA 320-c in response to the PPDU 315-b, where the BA 320-c indicates successful receipt of the PPDU 315-b. The STA 104-c may transmit, to the AP 102-b, a TXOP transfer 340 based on receiving the BA 320-c, where the TXOP transfer 340 indicates transfer of ownership, or use, of the TXOP 325-b from the STA 104-c to the AP 102-b. In some implementations, TXOP transfer 340 may be a MU RTS with an extension (such as a new extension) indicating the TXOP transfer 340 or may be a control frame (such as a new control frame) dedicated to the TXOP transfer 340.

As such, the AP 102-b may transmit, to the STA 104-c and in response to the TXOP transfer 340, a TXOP transfer response 345 acknowledging transfer of ownership of the TXOP 325-b. The AP 102-b may forward, or transmit, the PPDU 315-b (in the form of a downlink PPDU 315) to the STA 104-d based on transmitting the TXOP transfer response 345. Additionally, the STA 104-d may transmit, to the AP 102-b, a BA 320-d in response to receiving the PPDU 315-b.

Though described in the context of the STA 104-c transmitting a PPDU 315 to the STA 104-d via the AP 102-b, this is not to be regarded as a limitation of the present disclosure. In this regard, end-to-end TXOP techniques may similarly be employed for PPDUs 315 transmitted from the STA 104-d to the STA 104-c via the AP 102-b. Additionally, though described with reference to an AP 102 and multiple STAs 104, this is not to be regarded as a limitation of the present disclosure. In this regard, any type, or types, of wireless devices may support end-to-end TXOP techniques.

Further, although illustrated in the context of the STA 104-c initially transmitting to the AP 102-b to initiate the end-to-end relaying between the STA 104-c and the STA 104-d via the AP 102-b in the example of the signaling diagrams 300, the AP 102-b may alternatively provide an uplink trigger to the STA 104-c, and the STA 104-c may indicate a request for the AP 102-b to forward a PPDU 315 to the STA 104-c in association with (such as responsive to) receiving the uplink trigger. Additional details relating to such an uplink trigger-based mechanism are illustrated by and described with reference to FIG. 4.

FIG. 4 shows an example signaling diagram 400 that supports techniques for end-to-end operations between devices. The signaling diagram 400 may implement or may be implemented to realize aspects of the wireless communication network 100, the wireless communication network 200, the signaling diagrams 300, or any combination thereof. The signaling diagram 400 illustrates examples in which the AP 102-b may provide an uplink trigger to the STA 104-c and the STA 104-c may indicate a request for the AP 102-b to forward a PPDU to the STA 104-c in association with (such as responsive to) receiving the uplink trigger.

For example, the AP 102-b may transmit an uplink trigger 405 (such as a Trigger frame or an MU RTS TXOP sharing (TXS) frame, either or both of which may be understood as an uplink triggering frame) to the STA 104-c to solicit an uplink transmission from the STA 104-c. In some aspects, the uplink trigger 405 may solicit a PPDU 410 (such as an uplink PPDU, which may be equivalently understood as a data packet, a data message, or a data frame) from the STA 104-c. In some aspects, the uplink trigger 405 may explicitly or implicitly share a TXOP 425 of the AP 102-b with the STA 104-c. In association with (such as responsive to) receiving the uplink trigger 405 (such as the Trigger frame or the MU RTS TXS frame), the STA 104-c may request a short inter-frame space (SIFS) transmission (such as a SIFS forward or relay) to the STA 104-d using a header of the solicited PPDU 410 (which may be understood as a trigger-based (TB) uplink PPDU) or a header of an MPDU associated with the solicited PPDU 410. In some examples, the STA 104-c may request the SIFS transmission to the STA 104-d using a MAC header of the PPDU 410, such as via an HE A-Control field or frame. A request for a SIFS transmission may be understood as a request to forward, relay, or otherwise transmit a corresponding data packet within a SIFS or a point coordination function (PCF) inter-frame space (PIFS) separation of an associated BA (such as a BA 415).

In association with (such as responsive to) receiving the PPDU 410, the AP 102-b may transmit a BA 415 to acknowledge successful reception of the PPDU 410. In some aspects, the BA 415 may further be used by the AP 102-b to indicate acknowledgement of the request for the SIFS transmission to the STA 104-d. In some examples, the AP 102-b may attempt to lengthen a duration of the TXOP 425 (such as via a CTS-to-self (CTS2self) frame) in accordance with receiving the request for the SIFS transmission to the STA 104-d (if, for example, the AP 102-b determines, identifies, or otherwise ascertains that a remaining duration of the TXOP 425 might be insufficient to accommodate the requested SIFS transmission to the STA 104-d).

The AP 102-b may forward, or transmit, the PPDU 410 (in the form of a downlink PPDU 410) to the STA 104-d in association with receiving the PPDU 410 from the STA 104-c and in accordance with the request for the SIFS transmission to the STA 104-d. Additionally, in some aspects, the STA 104-d may transmit, to the AP 102-b, a BA 420 in response to receiving the PPDU 410.

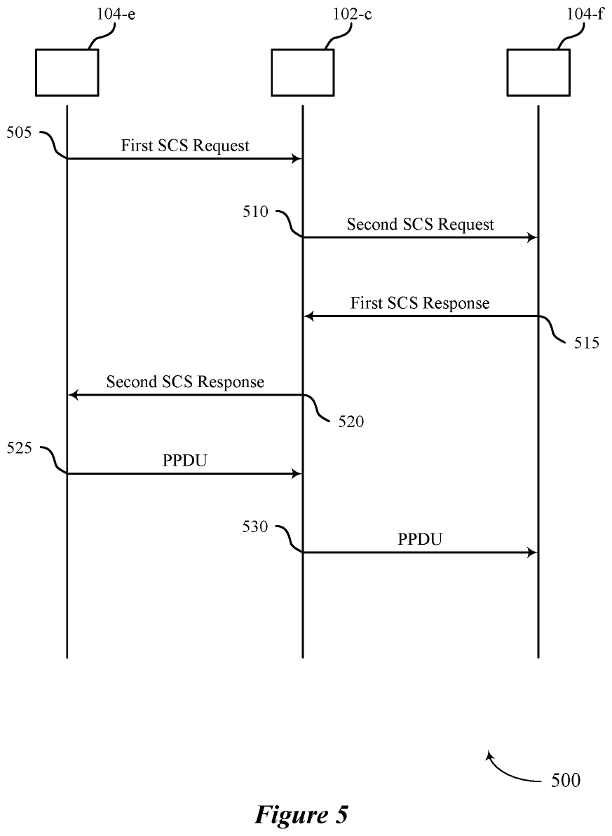

FIG. 5 shows an example process flow 500 that supports techniques for end-to-end operations between devices. The process flow 500 may implement or may be implemented to realize aspects of the wireless communication network 100, the wireless communication network 200, any one or more of the signaling diagrams 300, the signaling diagram 400, or any combination thereof.

In the following description of the process flow 500, the operations may be performed (such as reported or provided) in a different order than the order shown, or the operations performed by the example devices may be performed in different orders or at different times. Some operations also may be left out of the process flow 500, or other operations may be added to the process flow 500. Further, although some operations or signaling may be shown to occur at different times for discussion purposes, these operations may actually occur at the same time. The process flow 500 shows end-to-end QoS techniques in a scenario where an STA 104-e establishes an end-to-end connection with an STA 104-f via an AP 102-c, where the end-to-end connection includes a first communication link between the STA 104-e and the AP 102-c and a second communication link between the AP 102-c and the STA 104-f.

For example, at 505, the STA 104-e may transmit, to the AP 102-c, a first SCS request. The first SCS request may indicate an identity of the STA 104-f and may indicate one or more QoS parameters, where the one or more QoS parameters are common to PPDUs, or packets, transmitted via the first communication link and via the second communication link. Additionally, or alternatively, the first SCS request may include one or more parameters associated with the STA 104-f, such as an identifier indicating the identity of the STA 104-f.

At 510, the AP 102-c may transmit, to the STA 104-f, a second SCS request based on receiving the first SCS request. The second SCS request may configure the STA 104-f with the one or more QoS parameters. In other words, the STA 104-f may install, or apply, the one or more QoS parameters at the STA 104-f based on receiving the second SCS request. Installation of the one or more QoS parameters at, or on, the STA 104-f may be for uplink access of data flows, such as IP data flows, specified by the STA 104-e. In such implementations, the STA 104-f may support the AP 102-c configuring the one or more QoS parameters, or the AP 102-c installing uplink packet filtering (such that the STA 104-f may be 11be or beyond).

At 515, the STA 104-f may transmit, to the AP 102-c, a first SCS response based on receiving the second SCS request. The first SCS response may indicate a status of the configuration, or installation, of the one or more QoS parameters at the STA 104-f.

At 520, the AP 102-c may transmit, to the STA 104-e, a second SCS response based on receiving the first SCS response. The second SCS response may indicate a successful configuration, or installation, of the one or more QoS parameters at the STA 104-f.

At 525, the STA 104-e may transmit a PPDU, as an uplink PPDU, to the AP 102-c based on receiving the second SCS response.

At 530, the AP 102-c may forward the PPDU, as a downlink PPDU, to the STA 104-f in accordance with the QoS and based on receiving the PPDU from the STA 104-e, based on the status of the configuration of the one or more QoS parameters at the STA 104-f, or both. In other words, the AP 102-c may apply the one or more QoS parameters (specified by the STA 104-e) for downlink access to forward the PPDU to the STA 104-f (in accordance with the first SCS request). In such implementations, the AP 102-c may refrain from applying the one or more QoS parameters for other PPDUs, or packets, to be forwarded to the STA 104-e via other communication links, from other STAs 104, or the like thereof.

In some implementations, the STA 104-e may indicate, or prove, to the AP 102-c, that the STA 104-e is receiving uplink PPDUs, or packets, form the STA 104-f (as opposed to another STA 104 requesting for the AP 102-c to install parameters on the STA 104-f). Additionally, or alternatively, the STA 104-e, the AP 102-c, the STA 104-f, or any combination thereof, may support, or use, random MAC addresses. In such implementations, the AP 102-c may be aware of identities of the STA 104-e and the STA 104-f based on the MAC addresses.

In some implementations, the STA 104-f may not support the AP 102-c configuring the one or more QoS parameters on the STA 104-f, or the AP 102-c installing uplink packet filtering (such that the STA 104-f may be pre-11be). In such implementations, the AP 102-c may use trigger-based uplink access to serve the STA 104-f to support application of the one or more QoS parameters (to meet end-to-end QoS).

Though described in the context of the STA 104-e transmitting a PPDU to the STA 104-f via the AP 102-c, this is not to be regarded as a limitation of the present disclosure. In this regard, end-to-end QoS techniques may similarly be employed for PPDUs transmitted from the STA 104-e to the STA 104-f via the AP 102-c. Additionally, though described with reference to an AP 102 and multiple STAs 104, this is not to be regarded as a limitation of the present disclosure. In this regard, any type, or types, of wireless devices may support end-to-end QoS techniques.

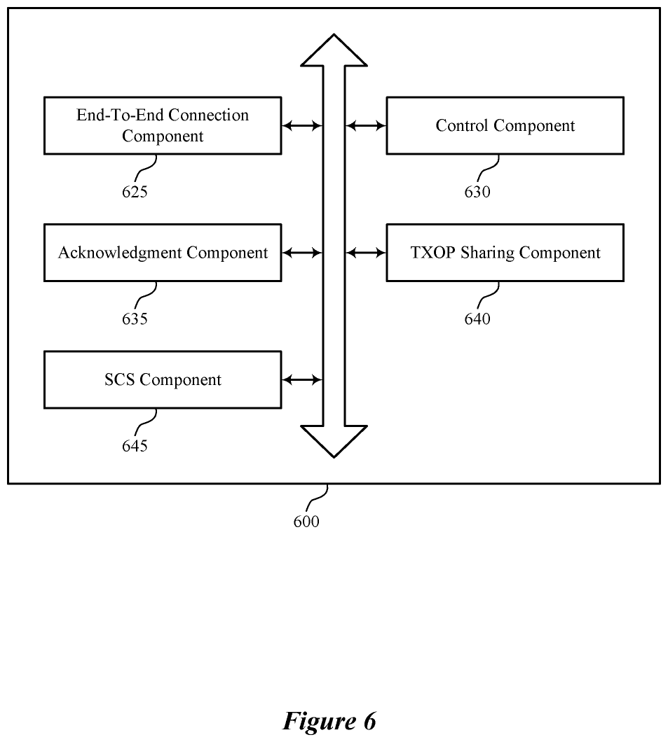

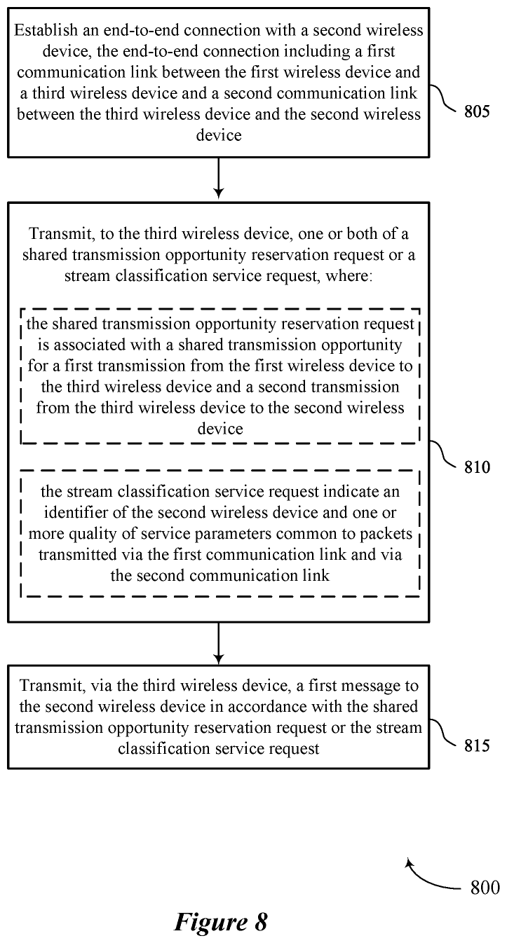

FIG. 6 shows a block diagram of an example wireless communication device 600 that supports techniques for end-to-end operations between devices. In some examples, the wireless communication device 600 is configured to perform the process 800 described with reference to FIG. 8. The wireless communication device 600 may include one or more chips, SoCs, chipsets, packages, components or devices that individually or collectively constitute or include a processing system. The processing system may interface with other components of the wireless communication device 600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 600 may transmit the information output from the chip. In such an example, the second interface may refer to an interface between the processing system of the chip and a reception component, such that the wireless communication device 600 may receive information that is passed to the processing system. In some such examples, the first interface also may obtain information, such as from the transmission component, and the second interface also may output information, such as to the reception component.

The processing system of the wireless communication device 600 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 600 can configurable or configured for use in a STA, such as the STA 104 described with reference to FIG. 1. In some other examples, the wireless communication device 600 can be a STA that includes such a processing system and other components including multiple antennas. The wireless communication device 600 is capable of transmitting and receiving wireless communications in the form of, for example, wireless packets. For example, the wireless communication device 600 can be configurable or configured to transmit and receive packets in the form of physical layer PPDUs and MPDUs conforming to one or more of the IEEE 802.11 family of wireless communication protocol standards. In some other examples, the wireless communication device 600 can be configurable or configured to transmit and receive signals and communications conforming to one or more 3GPP specifications including those for 5G NR or 6G. In some examples, the wireless communication device 600 also includes or can be coupled with one or more application processors which may be further coupled with one or more other memories. In some examples, the wireless communication device 600 further includes a user interface (UI) (such as a touchscreen or keypad) and a display, which may be integrated with the UI to form a touchscreen display that is coupled with the processing system. In some examples, the wireless communication device 600 may further include one or more sensors such as, for example, one or more inertial sensors, accelerometers, temperature sensors, pressure sensors, or altitude sensors, that are coupled with the processing system.

The wireless communication device 600 includes an end-to-end connection component 625, a control component 630, an acknowledgment component 635, a TXOP sharing component 640, and an SCS component 645. Portions of one or more of the end-to-end connection component 625, the control component 630, the acknowledgment component 635, the TXOP sharing component 640, and the SCS component 645 may be implemented at least in part in hardware or firmware. For example, one or more of the end-to-end connection component 625, the control component 630, the acknowledgment component 635, the TXOP sharing component 640, and the SCS component 645 may be implemented at least in part by at least a processor or a modem. In some examples, portions of one or more of the end-to-end connection component 625, the control component 630, the acknowledgment component 635, the TXOP sharing component 640, and the SCS component 645 may be implemented at least in part by a processor and software in the form of processor-executable code stored in memory.

The wireless communication device 600 may support wireless communications a first wireless device in accordance with examples as disclosed herein. The end-to-end connection component 625 is configurable or configured to establish an end-to-end connection with a second wireless device, the end-to-end connection including a first communication link between the first wireless device and a third wireless device and a second communication link between the third wireless device and the second wireless device. The control component 630 is configurable or configured to transmit, to the third wireless device, one or both of a shared TXOP reservation request or an SCS request. In some examples, the shared TXOP reservation request is associated with a shared TXOP for a first transmission from the first wireless device to the third wireless device and a second transmission from the third wireless device to the second wireless device and the SCS request indicates an identifier of the second wireless device and one or more QoS parameters common to packets transmitted via the first communication link and via the second communication link. In some examples, the end-to-end connection component 625 is configurable or configured to transmit, via the third wireless device, a first message to the second wireless device in accordance with the shared TXOP reservation request or the SCS request.

In some examples, the acknowledgment component 635 is configurable or configured to receive, from the third wireless device, an acknowledgment message in response to the first message. In some examples, the TXOP sharing component 640 is configurable or configured to transmit, to the third wireless device and in response to the acknowledgment message, a control frame indicating that the shared TXOP is transferred to the third wireless device.

In some examples, the acknowledgment component 635 is configurable or configured to receive, from the third wireless device and in response to the control frame, a second message acknowledging that the shared TXOP is transferred to the third wireless device.

In some examples, the control component 630 is configurable or configured to communicate, with the third wireless device, one or more management frames including information indicative of the identifier of the second wireless device and the one or more QoS parameters, where the one or more management frames are associated with a negotiation of the identifier of the second wireless device and the one or more QoS parameters between the first wireless device and the third wireless device.

In some examples, the TXOP sharing component 640 is configurable or configured to receive, from the third wireless device, an uplink trigger associated with the first message and transmit, via a header of an MPDU or a PPDU including the first message (or via a header of the first message itself), one or both of the shared TXOP reservation request or the SCS request.

In some examples, the shared TXOP reservation request is transmitted in accordance with a determination that the third wireless device is to forward the first message to the second wireless device via the second communication link for the end-to-end connection with the second wireless device.

In some examples, the shared TXOP reservation request further includes one or more parameters associated with the second wireless device. In some examples, the one or more parameters include the identifier of the second wireless device.

In some examples, the TXOP sharing component 640 is configurable or configured to receive, from the third wireless device, a shared TXOP reservation response that reserves the shared TXOP for the first transmission and the second transmission, the first message is transmitted in accordance with the shared TXOP reservation response.

In some examples, the SCS component 645 is configurable or configured to receive, from the third wireless device, an SCS response indicating a successful installation of the one or more QoS parameters at the second wireless device, the first message is transmitted in accordance with receiving the SCS response.

In some examples, the SCS request include one or more parameters associated with the second wireless device. In some examples, the one or more parameters include the identifier of the second wireless device.

In some examples, the one or both of the shared TXOP reservation request or the SCS request is transmitted via a control frame, or via a header of an MPDU or a PPDU including the first message (or via a header of the first message itself).

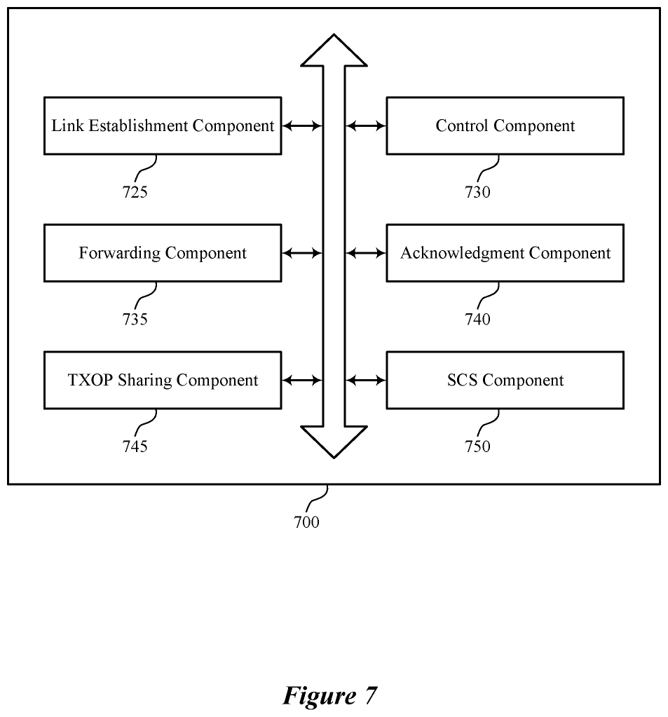

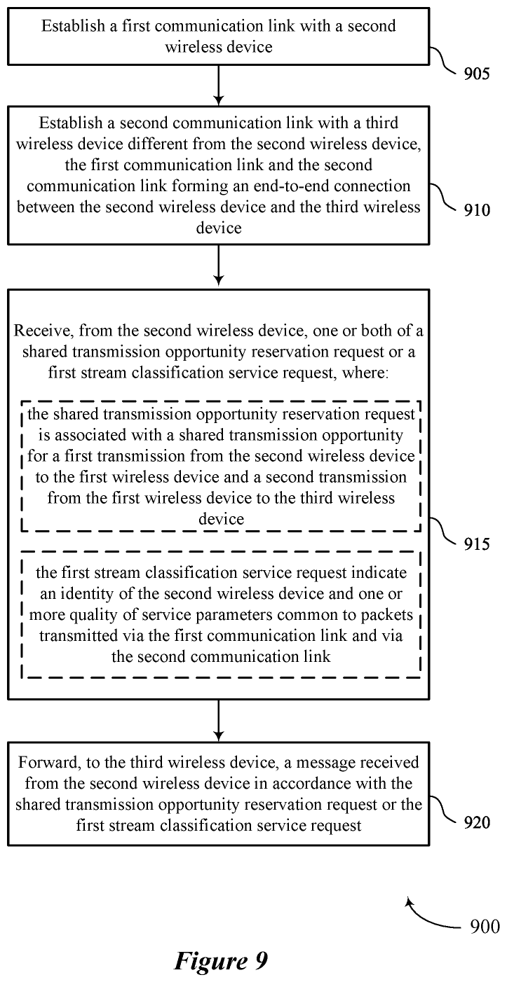

FIG. 7 shows a block diagram of an example wireless communication device 700 that supports techniques for end-to-end operations between devices. In some examples, the wireless communication device 700 is configured to perform the process 900 described with reference to FIG. 9. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 700 can configurable or configured for use in an AP, such as the AP 102 described with reference to FIG. 1. In some other examples, the wireless communication device 700 can be an AP that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes at least one external network interface coupled with the processing system that enables communication with a core network or backhaul network that enables the wireless communication device 700 to gain access to external networks including the Internet.

The wireless communication device 700 includes a link establishment component 725, a control component 730, a forwarding component 735, an acknowledgment component 740, a TXOP sharing component 745, and an SCS component 750. Portions of one or more of the link establishment component 725, the control component 730, the forwarding component 735, the acknowledgment component 740, the TXOP sharing component 745, and the SCS component 750 may be implemented at least in part in hardware or firmware. For example, one or more of the link establishment component 725, the control component 730, the forwarding component 735, the acknowledgment component 740, the TXOP sharing component 745, and the SCS component 750 may be implemented at least in part by at least a processor or a modem. In some examples, portions of one or more of the link establishment component 725, the control component 730, the forwarding component 735, the acknowledgment component 740, the TXOP sharing component 745, and the SCS component 750 may be implemented at least in part by a processor and software in the form of processor-executable code stored in memory.

The wireless communication device 700 may support wireless communication in accordance with examples as disclosed herein. The link establishment component 725 is configurable or configured to establish a first communication link with a second wireless device. In some examples, the link establishment component 725 is configurable or configured to establish a second communication link with a third wireless device different from the second wireless device, the first communication link and the second communication link forming an end-to-end connection between the second wireless device and the third wireless device. The control component 730 is configurable or configured to receive, from the second wireless device, one or both of a shared TXOP reservation request or a first SCS request. In some examples, the shared TXOP reservation request is associated with a shared TXOP for a first transmission from the second wireless device to the first wireless device and a second transmission from the first wireless device to the third wireless device and the first SCS request indicates an identifier of the third wireless device and one or more QoS parameters common to packets transmitted via the first communication link and via the second communication link. The forwarding component 735 is configurable or configured to forward, to the third wireless device, a message received from the second wireless device in accordance with the shared TXOP reservation request or the first SCS request.

In some examples, the forwarding component 735 is configurable or configured to receive the message from the second wireless device. In some examples, the acknowledgment component 740 is configurable or configured to transmit, to the second wireless device, an acknowledgment message in response to the message. In some examples, the control component 730 is configurable or configured to receive, from the second wireless device and in response to the acknowledgment message, a control frame indicating that the shared TXOP is transferred to the first wireless device, the message is forwarded to the third wireless device in accordance with the shared TXOP being transferred to the first wireless device.

In some examples, the acknowledgment component 740 is configurable or configured to transmit, to the second wireless device and in response to the control frame, a second message acknowledging that the shared TXOP is transferred to the first wireless device.

In some examples, the control component 730 is configurable or configured to communicate, with the second wireless device, one or more management frames including information indicative of the identifier of the third wireless device and the one or more QoS parameters, where the one or more management frames are associated with a negotiation of the identifier of the third wireless device and the one or more QoS parameters between the first wireless device and the third wireless device. In some examples, the TXOP sharing component 745 is configurable or configured to receive the shared transmission opportunity reservation request. In some examples, the forwarding component 735 is configurable or configured to select to forward the message to the third wireless device in accordance with the shared TXOP reservation request and the negotiation of the identifier of the third wireless device and the one or more QoS parameters.

In some examples, the control component 730 is configurable or configured to transmit, to the second wireless device, an uplink trigger associated with the first message and receive, via a header of an MPDU or a PPDU including the first message (or via a header of the first message itself), one or both of the shared TXOP reservation request or the SCS request.

In some examples, the shared TXOP reservation request includes one or more parameters associated with the third wireless device. In some examples, the one or more parameters include the identifier of the third wireless device. In some examples, the TXOP sharing component 745 is configurable or configured to transmit, to the second wireless device, a shared TXOP reservation response that reserves the shared TXOP for the first transmission and the second transmission, the message is forwarded in accordance with the shared TXOP reservation response.

In some examples, the SCS component 750 is configurable or configured to transmit, to the third wireless device, a second SCS request message to configure the third wireless device with the one or more QoS parameters. In some examples, the SCS component 750 is configurable or configured to receive, from the third wireless device, a first SCS response indicating a status of a configuration of the one or more QoS parameters at the third wireless device, the one or more QoS parameters are applied to the message forwarded to the third wireless device in accordance with the status of the configuration.

In some examples, the SCS component 750 is configurable or configured to transmit, to the second wireless device, a second SCS response indicating a successful installation of the one or more QoS parameters at the third wireless device in accordance with the status of the configuration, the message is received in accordance with receiving the second SCS response.

In some examples, the forwarding component 735 is configurable or configured to apply the one or more QoS parameters associated with the message for forwarding the message to the third wireless device in accordance with the first SCS request.

In some examples, one or both of the shared TXOP reservation request or the SCS request is received via a control frame, or via a header of an MPDU or a PPDU including the first message (or via a header of the first message itself).

FIG. 8 shows a flowchart illustrating an example process 800 performable by or at a first wireless device that supports techniques for end-to-end operations between devices. The operations of the process 800 may be implemented by an apparatus or its components as described herein. For example, the process 800 may be performed by a wireless communication device, such as the wireless communication device 600 described with reference to FIG. 6, operating as or within a wireless STA. In some examples, the process 800 may be performed by a wireless STA, such as one of the STAs 104 described with reference to FIG. 1.

In some examples, in block 805, the apparatus may establish an end-to-end connection with a second wireless device, the end-to-end connection including a first communication link between the first wireless device and a third wireless device and a second communication link between the third wireless device and the second wireless device. The operations of block 805 may be performed in accordance with examples as disclosed herein. In some implementations, aspects of the operations of block 805 may be performed by an end-to-end connection component 625 as described with reference to FIG. 6.

In some examples, in block 810, the apparatus may transmit, to the third wireless device, one or both of a shared TXOP reservation request or an SCS request. In some examples, the shared TXOP reservation request may be associated with a shared TXOP for a first transmission from the first wireless device to the third wireless device and a second transmission from the third wireless device to the second wireless device and the SCS request may indicate an identifier of the second wireless device and one or more QoS parameters common to packets transmitted via the first communication link and via the second communication link. The operations of block 810 may be performed in accordance with examples as disclosed herein. In some implementations, aspects of the operations of block 810 may be performed by a control component 630 as described with reference to FIG. 6.

In some examples, in block 815, the apparatus may transmit, via the third wireless device, a first message to the second wireless device in accordance with the shared TXOP reservation request or the SCS request. The operations of block 815 may be performed in accordance with examples as disclosed herein. In some implementations, aspects of the operations of block 815 may be performed by an end-to-end connection component 625 as described with reference to FIG. 6.

FIG. 9 shows a flowchart illustrating an example process 900 performable by or at a first wireless device that supports techniques for end-to-end operations between devices. The operations of the process 900 may be implemented by a first wireless device or its components as described herein. For example, the process 900 may be performed by a wireless communication device, such as the wireless communication device 700 described with reference to FIG. 7, operating as or within a wireless AP. In some examples, the process 900 may be performed by a wireless AP, such as one of the APs 102 described with reference to FIG. 1.

In some examples, in block 905, the first wireless device may establish a first communication link with a second wireless device. The operations of block 905 may be performed in accordance with examples as disclosed herein. In some implementations, aspects of the operations of block 905 may be performed by a link establishment component 725 as described with reference to FIG. 7.

In some examples, in block 910, the first wireless device may establish a second communication link with a third wireless device different from the second wireless device, the first communication link and the second communication link forming an end-to-end connection between the second wireless device and the third wireless device. The operations of block 910 may be performed in accordance with examples as disclosed herein. In some implementations, aspects of the operations of block 910 may be performed by a link establishment component 725 as described with reference to FIG. 7.

In some examples, in block 915, the first wireless device may receive, from the second wireless device, one or both of a shared TXOP reservation request or a first SCS request. In some examples, the shared TXOP reservation request may be associated with a shared TXOP for a first transmission from the second wireless device to the first wireless device and a second transmission from the first wireless device to the third wireless device and the first SCS request may indicate an identifier of the third wireless device and one or more QoS parameters common to packets transmitted via the first communication link and via the second communication link. The operations of block 915 may be performed in accordance with examples as disclosed herein. In some implementations, aspects of the operations of block 915 may be performed by a control component 730 as described with reference to FIG. 7.

In some examples, in block 920, the first wireless device may forward, to the third wireless device, a message received from the second wireless device in accordance with the shared TXOP reservation request or the first SCS request. The operations of block 920 may be performed in accordance with examples as disclosed herein. In some implementations, aspects of the operations of block 920 may be performed by a forwarding component 735 as described with reference to FIG. 7.

Implementation examples are described in the following numbered clauses:

Clause 1: A method for wireless communication by a first wireless device, including: establishing an end-to-end connection with a second wireless device, the end-to-end connection including a first communication link between the first wireless device and a third wireless device and a second communication link between the third wireless device and the second wireless device; transmitting, to the third wireless device, one or both of a shared transmission opportunity reservation request or a stream classification service request, where the shared transmission opportunity reservation request is associated with a shared transmission opportunity for a first transmission from the first wireless device to the third wireless device and a second transmission from the third wireless device to the second wireless device, and where the stream classification service request indicates an identifier of the second wireless device and one or more quality of service parameters common to packets transmitted via the first communication link and via the second communication link; and transmitting, via the third wireless device, a first message to the second wireless device in accordance with the shared transmission opportunity reservation request or the stream classification service request.

Clause 2: The method of clause 1, further including: receiving, from the third wireless device, an acknowledgment message in response to the first message; and transmitting, to the third wireless device and in response to the acknowledgment message, a control frame indicating that the shared transmission opportunity is transferred to the third wireless device.

Clause 3: The method of clause 2, further including: receiving, from the third wireless device and in response to the control frame, a second message acknowledging that the shared transmission opportunity is transferred to the third wireless device.

Clause 4: The method of any of clauses 1-3, further including: communicating, with the third wireless device, one or more management frames including information indicative of the identifier of the second wireless device and the one or more quality of service parameters, the one or more management frames being associated with a negotiation of the identifier of the second wireless device and the one or more quality of service parameters between the first wireless device and the third wireless device.

Clause 5: The method of any of clauses 1-4, further including: receiving, from the third wireless device, an uplink trigger associated with the first message; and transmitting, via a header of a medium access control (MAC) protocol data unit (MPDU) or a Physical Layer Convergence Protocol (PLCP) protocol data unit (PPDU) including the first message, one or both of the shared transmission opportunity reservation request or the stream classification service request.

Clause 6: The method of any of clauses 1-5, where the shared transmission opportunity reservation request is transmitted in accordance with a determination that the third wireless device is to forward the first message to the second wireless device via the second communication link for the end-to-end connection with the second wireless device.

Clause 7: The method of any of clauses 1-6, where the shared transmission opportunity reservation request further includes one or more parameters associated with the second wireless device.

Clause 8: The method of clause 7, where the one or more parameters include the identifier of the second wireless device.

Clause 9: The method of any of clauses 1-8, further including: receiving, from the third wireless device, a shared transmission opportunity reservation response that reserves the shared transmission opportunity for the first transmission and the second transmission, the first message is transmitted in accordance with the shared transmission opportunity reservation response.

Clause 10: The method of any of clauses 1-9, further including: receiving, from the third wireless device, a stream classification service response indicating a successful installation of the one or more quality of service parameters at the second wireless device, the first message is transmitted in accordance with receiving the stream classification service response.

Clause 11: The method of any of clauses 1-10, where the stream classification service request includes one or more parameters associated with the second wireless device.

Clause 12: The method of clause 11, where the one or more parameters include the identifier of the second wireless device.

Clause 13: The method of clause 1-12, where one or both of the shared transmission opportunity reservation request or the stream classification service request is transmitted via a control frame, or via a header of a medium access control (MAC) protocol data unit (MPDU) or a Physical Layer Convergence Protocol (PLCP) protocol data unit (PPDU) including the first message.

Clause 14: A method for wireless communication by a first wireless device, including: establishing a first communication link with a second wireless device; establishing a second communication link with a third wireless device different from the second wireless device, the first communication link and the second communication link forming an end-to-end connection between the second wireless device and the third wireless device; receiving, from the second wireless device, one or both of a shared transmission opportunity reservation request or a first stream classification service request, where the shared transmission opportunity reservation request is associated with a shared transmission opportunity for a first transmission from the second wireless device to the first wireless device and a second transmission from the first wireless device to the third wireless device, and where the first stream classification service request indicates an identifier of the third wireless device and one or more quality of service parameters common to packets transmitted via the first communication link and via the second communication link; and forwarding, to the third wireless device, a message received from the second wireless device in accordance with the shared transmission opportunity reservation request or the first stream classification service request.

Clause 15: The method of clause 14, further including: receiving the message from the second wireless device; transmitting, to the second wireless device, an acknowledgment message in response to the message; and receiving, from the second wireless device and in response to the acknowledgment message, a control frame indicating that the shared transmission opportunity is transferred to the first wireless device, the message is forwarded to the third wireless device in accordance with the shared transmission opportunity being transferred to the first wireless device.

Clause 16: The method of clause 15, further including: transmitting, to the second wireless device and in response to the control frame, a second message acknowledging that the shared transmission opportunity is transferred to the first wireless device.

Clause 17: The method of any of clauses 14-16, further including: communicating, with the second wireless device, one or more management frames including information indicative of the identifier of the third wireless device and the one or more quality of service parameters, the one or more management frames being associated with a negotiation of the identifier of the third wireless device and the one or more quality of service parameters between the first wireless device and the third wireless device; receiving the shared transmission opportunity reservation request; and selecting to forward the message to the third wireless device in accordance with the shared transmission opportunity reservation request and the negotiation of the identifier of the third wireless device and the one or more quality of service parameters.

Clause 18: The method of any of clauses 14-17, further including: transmitting, to the second wireless device, an uplink trigger associated with the message; and receiving, via a header of a medium access control (MAC) protocol data unit (MPDU) or a Physical Layer Convergence Protocol (PLCP) protocol data unit (PPDU) including the message, one or both of the shared transmission opportunity reservation request or the stream classification service request.

Clause 19: The method of any of clauses 14-18, where the shared transmission opportunity reservation request includes one or more parameters associated with the third wireless device.

Clause 20: The method of clause 19, where the one or more parameters include the identifier of the third wireless device.

Clause 21: The method of any of clauses 14-20, further including: transmitting, to the second wireless device, a shared transmission opportunity reservation response that reserves the shared transmission opportunity for the first transmission and the second transmission, the message is forwarded in accordance with the shared transmission opportunity reservation response.

Clause 22: The method of any of clauses 14-21, further including: transmitting, to the third wireless device, a second stream classification service request message to configure the third wireless device with the one or more quality of service parameters; and receiving, from the third wireless device, a first stream classification service response indicating a status of a configuration of the one or more quality of service parameters at the third wireless device, the one or more quality of service parameters are applied to the message forwarded to the third wireless device in accordance with the status of the configuration.

Clause 23: The method of clause 22, further including: transmitting, to the second wireless device, a second stream classification service response indicating a successful installation of the one or more quality of service parameters at the third wireless device in accordance with the status of the configuration, the message is received in accordance with receiving the second stream classification service response.

Clause 24: The method of any of clauses 14-23, further including: applying the one or more quality of service parameters associated with the message for forwarding the message to the third wireless device in accordance with the first stream classification service request.

Clause 25: The method of any of clauses 14-24, where one or both of the shared transmission opportunity reservation request or the stream classification service request is transmitted via a control frame, or via a header of a medium access control (MAC) protocol data unit (MPDU) or a Physical Layer Convergence Protocol (PLCP) protocol data unit (PPDU) including the message.

Clause 26: A first wireless device, including one or more memories storing processor-executable code, and one or more processors coupled with the one or more memories and individually or collectively operable to execute the code to cause the first wireless device to perform a method of any of clauses 1-13.

Clause 27: A first wireless device, including a processing system that includes processor circuitry and memory circuitry that stores code, the processing system configured to cause the first wireless device to perform a method of any of clauses 1-13.

Clause 28: A first wireless device, including at least one means for performing a method of any of clauses 1-13.

Clause 29: A non-transitory computer-readable medium storing code for wireless communication at a first wireless device, the code including instructions executable by one or more processors, individually or collectively, to (or to cause the first wireless device to) perform a method of any of clauses 1-13.

Clause 30: A first wireless device, including one or more memories storing processor-executable code, and one or more processors coupled with the one or more memories and individually or collectively operable to execute the code to cause the first wireless device to perform a method of any of clauses 14-26.

Clause 31: A first wireless device, including a processing system that includes processor circuitry and memory circuitry that stores code, the processing system configured to cause the first wireless device to perform a method of any of clauses 14-26.

Clause 32: A first wireless device, including at least one means for performing a method of any of clauses 14-26.

Clause 33: A non-transitory computer-readable medium storing code for wireless communication at a first wireless device, the code including instructions executable by one or more processors, individually or collectively, to (or to cause the first wireless device to) perform a method of any of clauses 14-26.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless device, comprising:
a processing system that includes processor circuitry and memory circuitry that stores code, the processing system configured to cause the first wireless device to:
establish an end-to-end connection with a second wireless device, the end-to-end connection comprising a first communication link between the first wireless device and a third wireless device and a second communication link between the third wireless device and the second wireless device;
transmit, to the third wireless device, one or both of a shared transmission opportunity reservation request or a stream classification service request, wherein:
the shared transmission opportunity reservation request is associated with a shared transmission opportunity for a first transmission from the first wireless device to the third wireless device and a second transmission from the third wireless device to the second wireless device, and
the stream classification service request indicates an identifier of the second wireless device and one or more quality of service parameters common to packets transmitted via the first communication link and via the second communication link; and
transmit, via the third wireless device, a first message to the second wireless device in accordance with the shared transmission opportunity reservation request or the stream classification service request.

2. The first wireless device of claim 1, wherein the processing system is further configured to cause the first wireless device to:
receive, from the third wireless device, an acknowledgment message in response to the first message; and
transmit, to the third wireless device and in response to the acknowledgment message, a control frame indicating that the shared transmission opportunity is transferred to the third wireless device.

3. The first wireless device of claim 2, wherein the processing system is further configured to cause the first wireless device to:
receive, from the third wireless device and in response to the control frame, a second message acknowledging that the shared transmission opportunity is transferred to the third wireless device.

4. The first wireless device of claim 1, wherein the processing system is further configured to cause the first wireless device to:
communicate, with the third wireless device, one or more management frames including information indicative of the identifier of the second wireless device and the one or more quality of service parameters, the one or more management frames being associated with a negotiation of the identifier of the second wireless device and the one or more quality of service parameters between the first wireless device and the third wireless device.

5. The first wireless device of claim 1, wherein the processing system is further configured to cause the first wireless device to:
receive, from the third wireless device, an uplink trigger associated with the first message; and
transmit, via a header of a medium access control (MAC) protocol data unit (MPDU) or a Physical Layer Convergence Protocol (PLCP) protocol data unit (PPDU) including the first message, one or both of the shared transmission opportunity reservation request or the stream classification service request.

6. The first wireless device of claim 1, wherein the shared transmission opportunity reservation request is transmitted in accordance with a determination that the third wireless device is to forward the first message to the second wireless device via the second communication link for the end-to-end connection with the second wireless device.

7. The first wireless device of claim 1, wherein the shared transmission opportunity reservation request further comprises one or more parameters associated with the second wireless device.

8. The first wireless device of claim 7, wherein the one or more parameters comprise the identifier of the second wireless device.

9. The first wireless device of claim 1, wherein the processing system is further configured to cause the first wireless device to:
receive, from the third wireless device, a shared transmission opportunity reservation response that reserves the shared transmission opportunity for the first transmission and the second transmission, the first message is transmitted in accordance with the shared transmission opportunity reservation response.

10. The first wireless device of claim 1, wherein the processing system is further configured to cause the first wireless device to:
receive, from the third wireless device, a stream classification service response indicating a successful installation of the one or more quality of service parameters at the second wireless device, the first message is transmitted in accordance with receiving the stream classification service response.

11. The first wireless device of claim 1, wherein the stream classification service request comprises one or more parameters associated with the second wireless device.

12. The first wireless device of claim 11, wherein the one or more parameters comprise the identifier of the second wireless device.

13. The first wireless device of claim 1, wherein one or both of the shared transmission opportunity reservation request or the stream classification service request is transmitted via a control frame, or via a header of a medium access control (MAC) protocol data unit (MPDU) or a Physical Layer Convergence Protocol (PLCP) protocol data unit (PPDU) including the first message.

14. A first wireless device, comprising:
a processing system that includes processor circuitry and memory circuitry that stores code, the processing system configured to cause the first wireless device to:
establish a first communication link with a second wireless device;
establish a second communication link with a third wireless device different from the second wireless device, the first communication link and the second communication link forming an end-to-end connection between the second wireless device and the third wireless device;
receive, from the second wireless device, one or both of a shared transmission opportunity reservation request or a first stream classification service request, wherein:
the shared transmission opportunity reservation request is associated with a shared transmission opportunity for a first transmission from the second wireless device to the first wireless device and a second transmission from the first wireless device to the third wireless device, and
the first stream classification service request indicates an identifier of the third wireless device and one or more quality of service parameters common to packets transmitted via the first communication link and via the second communication link; and
forward, to the third wireless device, a message received from the second wireless device in accordance with the shared transmission opportunity reservation request or the first stream classification service request.

15. The first wireless device of claim 14, wherein the processing system is further configured to cause the first wireless device to:
receive the message from the second wireless device;
transmit, to the second wireless device, an acknowledgment message in response to the message; and
receive, from the second wireless device and in response to the acknowledgment message, a control frame indicating that the shared transmission opportunity is transferred to the first wireless device, the message is forwarded to the third wireless device in accordance with the shared transmission opportunity being transferred to the first wireless device.

16. The first wireless device of claim 15, wherein the processing system is further configured to cause the first wireless device to:
transmit, to the second wireless device and in response to the control frame, a second message acknowledging that the shared transmission opportunity is transferred to the first wireless device.

17. The first wireless device of claim 14, wherein the processing system is further configured to cause the first wireless device to:
communicate, with the second wireless device, one or more management frames including information indicative of the identifier of the third wireless device and the one or more quality of service parameters, the one or more management frames being associated with a negotiation of the identifier of the third wireless device and the one or more quality of service parameters between the first wireless device and the third wireless device;
receive the shared transmission opportunity reservation request; and
select to forward the message to the third wireless device in accordance with the shared transmission opportunity reservation request and the negotiation of the identifier of the third wireless device and the one or more quality of service parameters.

18. The first wireless device of claim 14, wherein the shared transmission opportunity reservation request comprises one or more parameters associated with the third wireless device.

19. The first wireless device of claim 18, wherein the one or more parameters comprise the identifier of the third wireless device.

20. The first wireless device of claim 14, wherein the processing system is further configured to cause the first wireless device to:
transmit, to the second wireless device, a shared transmission opportunity reservation response that reserves the shared transmission opportunity for the first transmission and the second transmission, the message is forwarded in accordance with the shared transmission opportunity reservation response.

21. The first wireless device of claim 14, wherein the processing system is further configured to cause the first wireless device to:
transmit, to the third wireless device, a second stream classification service request message to configure the third wireless device with the one or more quality of service parameters; and
receive, from the third wireless device, a first stream classification service response indicating a status of a configuration of the one or more quality of service parameters at the third wireless device, the one or more quality of service parameters are applied to the message forwarded to the third wireless device in accordance with the status of the configuration.

22. The first wireless device of claim 21, wherein the processing system is further configured to cause the first wireless device to:
transmit, to the second wireless device, a second stream classification service response indicating a successful installation of the one or more quality of service parameters at the third wireless device in accordance with the status of the configuration, the message is received in accordance with receiving the second stream classification service response.

23. The first wireless device of claim 14, wherein the processing system is further configured to cause the first wireless device to:
apply the one or more quality of service parameters associated with the message for forwarding the message to the third wireless device in accordance with the first stream classification service request.

24. A method for wireless communication by a first wireless device, comprising:
establishing an end-to-end connection with a second wireless device, the end-to-end connection comprising a first communication link between the first wireless device and a third wireless device and a second communication link between the third wireless device and the second wireless device;
transmitting, to the third wireless device, one or both of a shared transmission opportunity reservation request or a stream classification service request, wherein:
the shared transmission opportunity reservation request is associated with a shared transmission opportunity for a first transmission from the first wireless device to the third wireless device and a second transmission from the third wireless device to the second wireless device, and
the stream classification service request indicates an identifier of the second wireless device and one or more quality of service parameters common to packets transmitted via the first communication link and via the second communication link; and
transmitting, via the third wireless device, a first message to the second wireless device in accordance with the shared transmission opportunity reservation request or the stream classification service request.

25. The method of claim 24, further comprising:
receiving, from the third wireless device, an acknowledgment message in response to the first message; and
transmitting, to the third wireless device and in response to the acknowledgment message, a control frame indicating that the shared transmission opportunity is transferred to the third wireless device.

26. The method of claim 25, further comprising:
receiving, from the third wireless device and in response to the control frame, a second message acknowledging that the shared transmission opportunity is transferred to the third wireless device.

27. The method of claim 24, further comprising:
receiving, from the third wireless device, a shared transmission opportunity reservation response that reserves the shared transmission opportunity for the first transmission and the second transmission, the first message is transmitted in accordance with the shared transmission opportunity reservation response.

28. A method for wireless communication by a first wireless device, comprising:
establishing a first communication link with a second wireless device;
establishing a second communication link with a third wireless device different from the second wireless device, the first communication link and the second communication link forming an end-to-end connection between the second wireless device and the third wireless device;
receiving, from the second wireless device, one or both of a shared transmission opportunity reservation request or a first stream classification service request, wherein:
the shared transmission opportunity reservation request is associated with a shared transmission opportunity for a first transmission from the second wireless device to the first wireless device and a second transmission from the first wireless device to the third wireless device, and
the first stream classification service request indicates an identifier of the third wireless device and one or more quality of service parameters common to packets transmitted via the first communication link and via the second communication link; and
forwarding, to the third wireless device, a message received from the second wireless device in accordance with the shared transmission opportunity reservation request or the first stream classification service request.

29. The method of claim 28, further comprising:
receiving the message from the second wireless device;
transmitting, to the second wireless device, an acknowledgment message in response to the message; and
receiving, from the second wireless device and in response to the acknowledgment message, a control frame indicating that the shared transmission opportunity is transferred to the first wireless device, the message is forwarded to the third wireless device in accordance with the shared transmission opportunity being transferred to the first wireless device.

30. The method of claim 29, further comprising:
transmitting, to the second wireless device and in response to the control frame, a second message acknowledging that the shared transmission opportunity is transferred to the first wireless device.
